(19) United States
(12) Patent Application Publication
(10) Pub. No.: US 2020/0241343 A1
(43) Pub. Date: Jul. 30, 2020

(54) LIQUID CRYSTAL PANEL AND LIQUID CRYSTAL DISPLAY DEVICE EQUIPPED WITH SAME

(71) Applicant: Mitsubishi Electric Corporation, Chiyoda-ku (JP)

(72) Inventors: Manabu IWAKAWA, Tokyo (JP); Naoko IWASAKI, Tokyo (JP); Toshiaki FUJINO, Tokyo (JP); Akira TAMATANI, Kumamoto (JP); Kazushi KIYOTA, Kumamoto (JP); Hironori MATSUEDA, Kumamoto (JP)

(73) Assignee: Mitsubishi Electric Corporation, Chiyoda-ku (JP)

(21) Appl. No.: 16/756,012

(22) PCT Filed: Aug. 8, 2018
(86) PCT No.: PCT/JP2018/029739

§ 371 Date: Apr. 14, 2020

(30) Foreign Application Priority Data
Dec. 21, 2017 (JP) 2017-245038

(51) Int. Cl. G02F 1/13363; G02F 1/1368; G02F 1/1335

(52) U.S. Cl. CPC G02F 1/13363; G02F 1/1368; G02F 2001/133531; G02F 2413/12; G02F 1/133528

(57) ABSTRACT

An absorption axis of the second polarizing plate provided on a counter substrate is parallel to an alignment axis of the liquid crystal molecules of a liquid crystal layer, the biaxial retardation film is arranged such that a slow axis of the biaxial retardation film forms a first angle formed counterclockwise with the absorption axis or formed clockwise with the alignment axis in a plane of the liquid crystal panel, and a transmission axis of a first polarizing plate provided on an array substrate is arranged such that the transmission axis of the first polarizing plate forms a second angle larger than the first angle from the absorption axis or the alignment axis in the same direction as the first angle in the plane of the liquid crystal panel.

### TECHNICAL FIELD

The present invention relates to a liquid crystal panel and a liquid crystal display device equipped with the same.

### BACKGROUND ART

A conventional liquid crystal display device including a liquid crystal panel includes an array substrate having, for example, a plurality of switching elements consisting of thin film transistors, pixel electrodes, and common electrodes arranged in a matrix on a transparent substrate, a color filter substrate consisting of a transparent substrate which is arranged to face the array substrate and on which a color filter is arranged, and a liquid crystal panel sandwiched between the array substrate and the color filter substrate and having a liquid crystal layer composed of liquid crystal molecules. A polarizing plate is provided on each of the array substrate and the color filter substrate.

In general, liquid crystal display devices are not only widely used in televisions and personal computers, but are also used in in-vehicle applications as display devices for car navigation devices. In this case, the liquid crystal display device is viewed from the driver's seat and the passenger seat, not only visibility from the front direction but also visibility when viewed from the driver's seat and the passenger seat are required.

Patent Document 1 discloses a configuration in which a biaxial retardation film is provided between the array substrate and a polarizing plate arranged on the array substrate side to improve the visibility when the liquid crystal display is viewed from above, and either the direction of the slow axis of the biaxial retardation film and the transmission axis of the polarizing plate arranged on the array substrate side, or any one of the direction of the absorption axis on the color filter substrate side and the alignment direction of the liquid crystal molecules is shifted.

Patent Document 2 discloses a configuration in which one axis angle of the polarizing plate provided on one of the array substrate and the color filter substrate is shifted in order to improve a viewing angle characteristic when the liquid crystal display device is viewed from an oblique direction.

### PRIOR ART DOCUMENTS

### Patent Documents

[Patent Document 1] Japanese Patent Application Laid-Open No. 2016-66022

[Patent Document 2] Japanese Patent Application Laid-Open No. 2010-169785

### SUMMARY

### Problem to be Solved by the Invention

However, the liquid crystal display device as disclosed in Patent Document 1 has the configuration in which either the direction of the slow axis of the biaxial retardation film and the transmission axis of the polarizing plate arranged on the array substrate side, or any one of the direction of the absorption axis on the color filter substrate side and the alignment direction of the liquid crystal molecules is shifted; therefore, depending on the item to be shifted, the visibility of the liquid crystal display device from the upper right and left oblique directions when it is viewed from the driver's seat or the passenger seat, is lowered.

Further, in the case of a liquid crystal display device as disclosed in Patent Document 2, only the viewing angle characteristic when the liquid crystal display device is viewed from an oblique direction is improved, and the visibility in the front direction is lowered; therefore, there is a problem that it is not suitable for a regular liquid crystal display device.

Therefore, the present invention has been made in order to solve such a technological problem of the conventional art and has an object to provide a liquid crystal panel and a liquid crystal display device including the liquid crystal panel that realize a suitable viewing angle characteristic, in a case, while maintaining a favorable visibility from the front direction of the liquid crystal display device, where the liquid crystal display device is viewed from the upper right and left oblique directions, for example, the driver's seat and the passenger seat of a vehicle.

### Means to Solve the Problem

In order to achieve the above object, the liquid crystal panel of the present invention includes an array substrate having a plurality of switching elements arranged in a matrix on a transparent substrate, a counter substrate arranged opposite to the array substrate, and a liquid crystal layer sandwiched between the array substrate and the counter substrate and composed of liquid crystal molecules. The array substrate includes a biaxial retardation film provided on an opposite side of a surface of the transparent substrate on which the switching elements are formed, and a first polarizing plate provided by lamination on the biaxial retardation film. The counter substrate includes a second polarizing plate provided on a side opposite to a side facing the liquid crystal layer. An absorption axis of the second polarizing plate is parallel to an alignment axis of the liquid crystal molecules. The biaxial retardation film is arranged such that the slow axis of the biaxial retardation film forms a first angle formed counterclockwise from an absorption axis direction or formed clockwise from an alignment axis direction in a plane of the liquid crystal panel. The first polarizing plate is arranged such that the transmission axis of the first polarizing plate forms a second angle larger than the first angle from the absorption axis direction or the alignment axis direction in the same direction as the first angle in the plane of the liquid crystal panel.

### Effects of the Invention

The liquid crystal display panel and the liquid crystal display device including thereof having the above-described configuration provide the liquid crystal display panel and the liquid crystal display device including thereof that realize a suitable viewing angle characteristic, in a case, while maintaining a favorable visibility from the front direction of the liquid crystal display device, where the liquid crystal display device is viewed from the upper right and left oblique directions, for example, the driver's seat and the passenger seat of a vehicle.

### BRIEF DESCRIPTION OF DRAWINGS

FIG. 1 is a schematic plan view illustrating a configuration of a liquid crystal panel provided in a liquid crystal display device according to Embodiment 1 of the present invention.

FIG. 2 is a schematic cross-sectional view of the liquid crystal panel 1 taken along section line AA in FIG. 1.

FIG. 3 is a schematic plan view illustrating a configuration in which one pixel of the liquid crystal panel 1 of FIG. 1 is enlarged.

FIG. 4 is a schematic plan view illustrating a configuration of liquid crystal molecules 42 of the liquid crystal panel 1 of FIG. 1.

FIG. 5 is a diagram illustrating an example of the liquid crystal panel according to Embodiment 1 of the present invention.

FIG. 6 is a schematic diagram for explaining features of the liquid crystal panel 1 according to Embodiment 1 of the present invention.

FIG. 7 is a graph illustrating a relationship between a first deviation angle θ₅ which is an angle formed between a slow axis 71 of the biaxial retardation film 70 and an absorption axis 91 of the color filter-side polarizing plate 90 and a contrast ratio in an upper right and left oblique directions according to Embodiment 1 of the present invention.

Part (a) of FIG. 8 is a graph illustrating a relationship of corresponding absorption axis angle θ₁ in an angle range of the first deviation angle θ₅ in which a contrast ratio of both in the upper left oblique direction and in the upper right oblique direction illustrated in FIG. 7 exceeds 1 and part (b) of FIG. 8 is a graph illustrating a relationship of corresponding absorption axis angle θ₁ in an angle range of the first deviation angle θ₅ in which a contrast ratio of both in the upper left oblique direction and the upper right oblique direction illustrated in FIG. 7 exceeds 1.2.

FIG. 9 is a graph in which the conventional example, a configuration in which only the slow axis 71 of the biaxial retardation film 70 is shifted, a configuration in which only the transmission axis 81 of the array substrate-side polarizing plate 80 is shifted, and a configuration of Embodiment 1 are compared, in terms of the contrast ratio when observed from the upper left oblique direction and the upper right oblique direction according to Embodiment 1 of the present invention.

Part (a) of FIG. 10 is a graph illustrating a relationship of corresponding absorption axis angle θ₁ in an angle range of the first deviation angle θ₅ in which a contrast ratio of both in the upper left oblique direction and the upper right oblique direction exceeds 1 when θ₆=1.5·θ₅ and part (b) of FIG. 10 is a graph illustrating a relationship of corresponding absorption axis angle θ₁ in an angle range of the first deviation angle θ₅ in which a contrast ratio of both in the upper left oblique direction and the upper right oblique direction exceeds 1.2 when θ₆=1.5·θ₅.

Part (a) of FIG. 11 is a graph illustrating a relationship of corresponding absorption axis angle θ₁ in an angle range of the first deviation angle θ₅ in which a contrast ratio of both in the upper left oblique direction and the upper right oblique direction exceeds 1 when θ₆=2.5·θ₅ and part (b) of FIG. 11 is a graph illustrating a relationship of corresponding absorption axis angle θ₁ in an angle range of the first deviation angle θ₅ in which a contrast ratio of both in the upper left oblique direction and the upper right oblique direction exceeds 1.2 when θ₆=2.5·θ₅.

FIG.12 is a schematic cross-sectional view of the liquid crystal panel 1 taken along section line AA in FIG. 1 according to Embodiment 2 of the present invention.

FIG. 13 is a graph illustrating the relationship between a first deviation angle θ₅ which is an angle formed between a slow axis 71 of the biaxial retardation film 70 and an absorption axis 91 of the color filter-side polarizing plate 90 and a contrast ratio in an upper right and left oblique directions according to Embodiment 2 of the present invention.

Part (a) of FIG. 14 is a graph illustrating a relationship of corresponding absorption axis angle θ₁ in an angle range of the first deviation angle θ₅ in which a contrast ratio of both in the upper left oblique direction and the upper right oblique direction illustrated in FIG. 13 exceeds 1 and part (b) of FIG. 14 is a graph illustrating a relationship of corresponding absorption axis angle θ₁ in an angle range of the first deviation angle θ₅ in which a contrast ratio of both in the upper left oblique direction and the upper right oblique direction illustrated in FIG. 13 exceeds 1.2.

FIG. 15 is a graph in which the conventional example, a configuration in which only the slow axis 71 of the biaxial retardation film 70 is shifted, a configuration in which only the transmission axis 81 of the array substrate-side polarizing plate 80 is shifted, and a configuration of Embodiment 2 are compared, in terms of the contrast ratio when observed from the upper left oblique direction and the upper right oblique direction according to Embodiment 2 of the present invention.

Part (a) of FIG. 16 is a graph illustrating a relationship of corresponding absorption axis angle θ₁ in an angle range of the first deviation angle θ₅ in which a contrast ratio of both in the upper left oblique direction and the upper right oblique direction exceeds 1 when θ₆=1.5·θ₅ and part (b) of FIG. 16 is a graph illustrating a relationship of corresponding absorption axis angle θ₁ in an angle range of the first deviation angle θ₅ in which a contrast ratio of both in the upper left oblique direction and the upper right oblique direction exceeds 1.2 when θ₆=1.5·θ₅.

Part (a) of FIG. 17 is a graph illustrating a relationship of corresponding absorption axis angle θ₁ in an angle range of the first deviation angle θ₅ in which a contrast ratio of both in the upper left oblique direction and the upper right oblique direction exceeds 1 when θ₆=2.5·θ₅ and part (b) of FIG. 17 is a graph illustrating a relationship of corresponding absorption axis angle θ₁ in an angle range of the first deviation angle θ₅ in which a contrast ratio of both in the upper left oblique direction and the upper right oblique direction exceeds 1.2 when θ₆=2.5·θ₅.

### DESCRIPTION OF EMBODIMENTS

### Embodiment 1

First, the configuration of the liquid crystal panel of the liquid crystal display device of the present invention will be described with reference to the drawings. It should be noted that the drawings are schematic and are intended to conceptually explain functions and structures. Further, the present invention is not limited by Embodiments described below. Except where otherwise noted, the basic configuration of the liquid crystal panel of the liquid crystal display device is common to all Embodiments. Also, the components denoted by the same reference numerals are the same or equivalent, and this is common in the entire text of the specification.

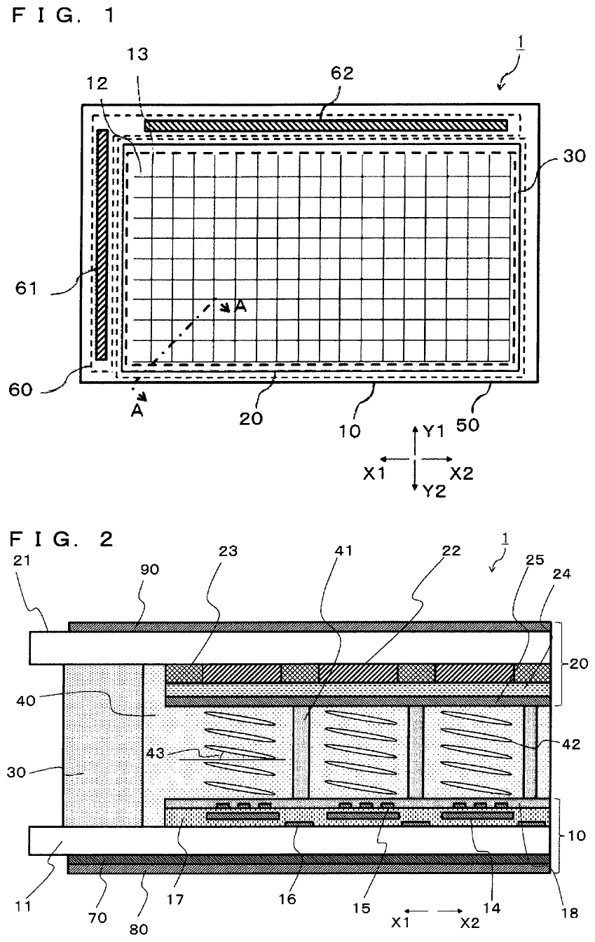

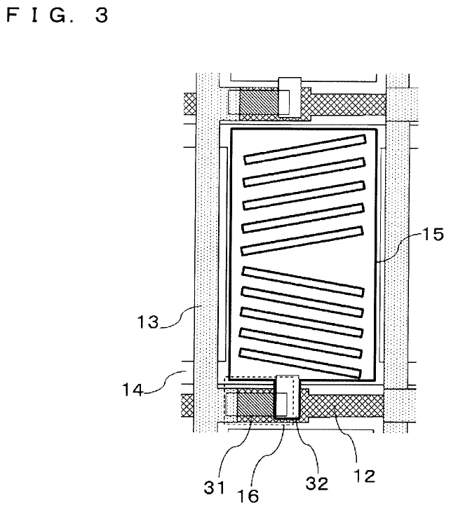

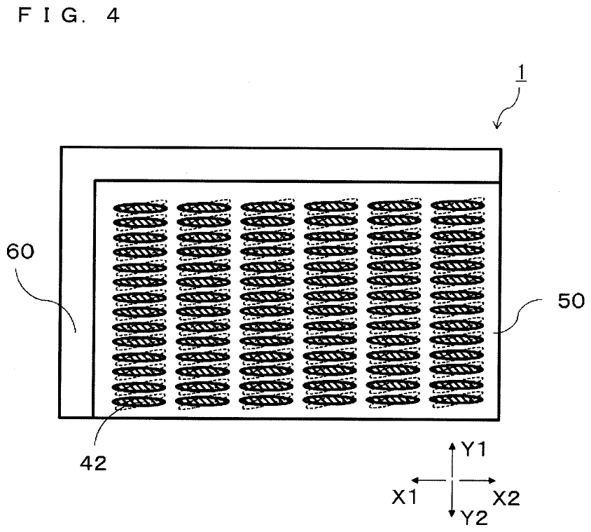

FIG. 1 is a schematic plan view illustrating a configuration of a liquid crystal panel 1 provided in a liquid crystal display device according to Embodiment 1 of the present invention. FIG. 2 is a schematic cross-sectional view of the liquid crystal panel 1 taken along section line AA in FIG. 1. FIG. 3 is a schematic plan view illustrating a configuration in which one pixel of the liquid crystal panel 1 of FIG. 1 is enlarged. FIG. 4 is a schematic plan view illustrating an example of arrangement of liquid crystal molecules 42 of the liquid crystal panel 1 of FIG. 1.

FIGS. 1 and 2 illustrate, as an example, a liquid crystal panel 1 of a transverse electric field system in which thin film transistors (TFTs) are used and operated as switching elements. More specifically, the liquid crystal panel 1 is a liquid crystal panel using an in plane switching (IPS) method or a fringe field switching (FFS) method.

As illustrated in FIGS. 1 and 2, the liquid crystal panel 1 includes a TFT array substrate 10 (hereinafter, referred to as an array substrate), a color filter substrate 20, which is a counter substrate, a sealing material 30, and a liquid crystal layer 40.

Hereinafter, the long side direction of the array substrate 10 and the color filter substrate 20 will be referred to the X direction, and the short side direction will be referred to the Y direction. The X direction and the Y direction are orthogonal to each other. In FIG. 1, the X direction is the horizontal direction within the surface of the liquid crystal panel 1 with respect to the display screen of the liquid crystal panel 1, that is, the right and left direction toward the sheet surface, and the Y direction is the vertical direction within the surface of the liquid crystal panel 1 with respect to the display screen of the liquid crystal panel 1 that is, the up and down direction toward the sheet surface.

In the X direction, one direction is defined as the X1 direction, and the other direction is defined as the X2 direction. In the Y direction, one direction is defined as the Y1 direction, and the other direction is defined as the Y2 direction. Here, the left direction within the surface of the liquid crystal panel 1 with respect to the display screen of the liquid crystal panel 1, that is, the direction from the right side to the left side on the sheet of FIG. 1 is defined as the X1 direction, and the right direction within the surface of the liquid crystal panel 1 with respect to the display screen of the liquid crystal panel 1, that is, the direction from the left side to the right side on the sheet of FIG. 1 is defined as the X2 direction. Also, the upper direction within the surface of the liquid crystal panel 1 with respect to the display screen of the liquid crystal panel 1, that is, the direction toward upper on the sheet of FIG. I is defined as the Y1 direction, and the downward direction within the surface of the liquid crystal panel 1 with respect to the display screen of the liquid crystal panel 1, that is, the direction toward downward on the sheet of FIG. 1 is defined as the Y2 direction.

The array substrate 10 includes, for example, a transparent substrate 11 made of a glass substrate, and is roughly divided into a display area 50 in which the TFTs 16 are arranged in a matrix and a frame area 60 provided so as to enclose the display area 50.

The color filter substrate 20 is disposed in the display area 50 at a position facing the array substrate 10 at a predetermined distance, and a liquid crystal layer 40 is sandwiched between the array substrate 10 and the color filter substrate 20. Further, the sealing material 30 is disposed so as to enclose an area corresponding to the display area 50, and seals a gap between the color filter substrate 20 and the array substrate 10.

In the display area 50 between the array substrate 10 and the color filter substrate 20, many columnar spacers 41 are arranged. The columnar spacers 41 form and hold gaps at a fixed distance between the array substrate 10 and the color filter substrate 20.

In the display area 50 in the array substrate 10, a plurality of gate electrodes 12 and a plurality of source electrodes 13 are arranged to intersect with each other so as to be orthogonal to each other. Corresponding to areas enclosed by the intersecting gate electrodes 12 and source electrodes 13, common electrodes 14, pixel electrodes 15 and TFTs 16 as switching elements are arranged in a matrix on the side of the transparent substrate 11 facing the color filter substrate 20.

The common electrode 14 and the pixel electrode 15 are a pair of electrodes that generate an electric field in a direction parallel to the substrate surface of the array substrate 10 and apply a voltage for driving the liquid crystal, and each of which is formed of a transparent conductive film. The TFT 16 is a switching element that applies a voltage to the common electrode 14 of the pair of electrodes.

The common electrode 14 and the TFT 16 are covered with an insulating film 17. The pixel electrode 15 is provided so as to face the common electrode 14 via the insulating film 17. On the insulating film 17, an alignment film 18 for aligning the liquid crystal is provided so as to cover the pixel electrodes 15.

As illustrated in FIG. 3, the common electrode 14 and the pixel electrode 15 are formed in an area enclosed by the gate electrode 12 and the source electrode 13, and the enclosed area is one unit of pixel for the pixel area and each of the areas is arranged in a matrix. The common electrode 14 has a rectangular shape, and the pixel electrode 15 has slit-shaped openings as illustrated in FIG. 3 so as to face the common electrode 14. The extending direction of the slit-shaped opening is formed at an angle of 0 to 15° from the left-right direction in the display surface of the liquid crystal panel, and the slit-shaped opening is arranged vertically symmetric with the central part of the common electrode 14 as a symmetric axis.

Further, as illustrated in FIG. 3, the TFT 16 is also provided near the intersection of the gate electrode 12 and the source electrode 13 for each unit of a pixel in the pixel area. On the gate electrode 12, a semiconductor channel layer 31 is provided via a gate insulating film (not illustrated). One end of the semiconductor channel layer 31 is electrically connected to the source electrode 13. The other end of the semiconductor channel layer 31 is electrically connected to a drain electrode 32. The drain electrode 32 is electrically connected to the pixel electrode 15.

The gate electrode 12 and the source electrode 13 are electrodes for supplying a signal to the TFT 16, and the gate electrode 12 serves as a scanning signal line and the source electrode 13 serves as a display signal line, respectively. The gate electrode 12 is electrically connected to a scanning signal drive circuit 61 provided in the frame area 60, and the source electrode 13 is electrically connected to a display signal drive circuit 62, respectively.

Further, of the display area 50 in the array substrate 10, on the transparent substrate 11 opposite to the surface on which the common electrodes 14, the pixel electrodes 15 and the TFTs 16 are formed, the biaxial retardation film 70 and the array substrate-side polarizing plate 80 that is the first polarizing plate are sequentially laminated. Detailed configurations of the biaxial retardation film 70 and the array substrate-side polarizing plate 80 will be described later.

Note that the above configuration is not inevitable. The configuration may be adoptable in which, for the common electrode 14 and the pixel electrode 15, the respective shapes thereof and the vertical arrangement relation thereof are reversed, the common electrode 14 is arranged above the pixel electrode 15 as a pattern in which a plurality of slit-shaped openings are formed in parallel, the pixel electrode 15 has a flat plate shape and is arranged below the common electrode 14, and the TFT 16 is electrically connected to the common electrode 14 having the pattern having a plurality of slit-shaped openings to apply a voltage.

The color filter substrate 20 includes, for example, a transparent substrate 21 made of transparent glass. On the surface of the transparent substrate 21 facing the array substrate, the color filters 22 as color material layers are provided, and light shielding layers 23 are provided between the color filters 22 or to the frame area 60 disposed outside the area corresponding to the display area 50 to shield the light. On the color filters 22 and the light shielding layers 23, an overcoat film 24 which is an organic flat film for suppressing a step between the color filters 22 is disposed. Further, on the overcoat film 24, an alignment film 25 for aligning the liquid crystal is disposed.

The color filter 22, for example, is configured of a color material layer in which a pigment or the like is dispersed in a resin and functions as a filter that selectively transmits light in a specific wavelength range such as red, green, and blue, for example, and color material layers of different colors are regularly arranged.

A light shielding layer 23 is made of, for example, a metal-based material using chromium oxide or the like, or a resin-based material in which black particles are dispersed in a resin.

On the side of the transparent substrate 21 opposite to the surface facing the array substrate, a color filter-side polarizing plate 90 as a second polarizing plate is provided. The detailed configuration of the color filter-side polarizing plate 90 will be described later.

The liquid crystal layer 40 sandwiched between the array substrate 10 and the color filter substrate 20 has liquid crystal molecules 42 aligned in a predetermined direction (alignment direction) by the alignment films 18 and 25, and has a pretilt angle 43.

Here, the alignment direction refers to a direction in which the alignment films 18 and 25 have been subjected to an alignment treatment such as rubbing. The pretilt angle refers to an angle formed by the long axis of each liquid crystal molecule 42 and a surface of the array substrate 10 or the color filter substrate 20 facing the liquid crystal layer 40 when no voltage is applied to the liquid crystal layer 40.

FIG. 4 is a diagram for explaining the alignment direction of the liquid crystal molecules 42 arranged in the display area 50. The liquid crystal molecules 42 illustrated by solid lines and oblique lines show the case where the alignment direction is set to a horizontal direction (X direction) of the liquid crystal panel 1. Further, the liquid crystal molecules 42 illustrated by the dotted lines in FIG. 4 show a case where the alignment direction is inclined in the Y direction with respect to the X direction.

Further, as illustrated in FIG. 1, the pretilt angle 43 of the liquid crystal molecules 42 in this Embodiment is set so that the liquid crystal molecules 42 are separated from the array substrate 10 in the X1 direction on the array substrate 10 side. On the color filter substrate 20 side, the pretilt angle 43 of the liquid crystal molecules 42 is set so that the liquid crystal molecules 42 are separated from the color filter substrate 20 in the X2 direction. That is, the pretilt angle 43 of the liquid crystal molecules 42 is an angle formed clockwise, from the surface of the array substrate 10, in the direction from the array substrate 10 toward the color filter substrate 20 on the array substrate 10 side, and on the color filter substrate 20 side, the pretilt angle 43 is an angle formed clockwise, from the surface of the color filter substrate 20, in the direction from the color filter substrate 20 toward the array substrate 10. Here, the pretilt angle 43 is, for example, 1.0° to 2.0°.

In the liquid crystal panel I configured as described above, a plurality of pads electrically connected to each of the drive circuits 61, 62 are arranged in the longitudinal direction and the lateral direction of the liquid crystal panel end in order to connect to a control IC chip that drives and controls a scanning signal drive circuit 61 and a display signal drive circuit 62. The plurality of pads are electrically connected to the control IC chip or the like provided on a control board via a flexible flat cable serving as connection wiring.

Control signals from the control IC chip or the like are input to the input sides of the drive circuits 61 and 62 via the flexible flat cable. Output signals output from the output sides of the drive circuits 61 and 62 are supplied to the TFT 16 in the display area 50 via a number of signal extraction wirings (not shown) extracted from the display area 50.

The liquid crystal display device of this Embodiment includes the liquid crystal panel 1 configured as described above, a backlight unit (not shown), an optical sheet (not shown), and a housing (not shown).

The backlight unit corresponds to a lighting device such as an LED. The backlight unit is disposed on the liquid crystal panel 1 on the side opposite to the display surface formed in the display area 50 of the color filter substrate 20 via an optical sheet. The backlight unit faces the substrate surface of the array substrate 10 and is a light source. The optical sheet has a function of adjusting light (backlight light) from the backlight unit.

The housing has a shape in which a display surface portion of the display area 50 is open. The liquid crystal display device is configured such that a liquid crystal panel 1 housed in a housing together with an optical members such as the above-described backlight unit and an optical sheet.

Next, the specific configurations of the biaxial retardation film 70, the array substrate-side polarizing plate 80, and the color filter-side polarizing plate 90, and the effects obtained thereby will be described.

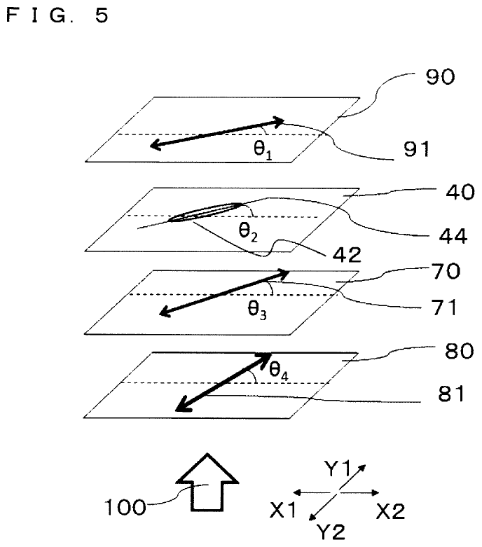

FIG. 5 is a diagram illustrating an example of an arrangement of optical components in the liquid crystal panel 1 of this Embodiment. FIG. 5 illustrates the biaxial retardation film 70, the array substrate-side polarizing plate 80, the liquid crystal layer 40, and the color filter-side polarizing plate 90 as optical components.

The color filter-side polarizing plate 90 is arranged so that the absorption axis 91 forms an absorption axis angle θ₁ counterclockwise in the Y1 direction with respect to the X direction.

The liquid crystal molecules 42 in the liquid crystal layer 40 are arranged such that the alignment axis 44 forms an alignment axis angle θ₂ counterclockwise in the Y1 direction with respect to the X direction. That is, when the alignment axis angle θ₂ is 0°, the liquid crystal molecules 42 are arranged so that the alignment direction of the liquid crystal molecules 42 is parallel to the horizontal X direction, as in the case of the liquid crystal molecules 42 shown by solid lines and oblique lines in FIG. 4. When the alignment axis angle θ₂ has a predetermined angle other than 0°, the alignment direction of the liquid crystal molecules 42 has a predetermined inclination in the Y1 direction with respect to the X direction, as in the liquid crystal molecules 42 shown by the dotted line in FIG. 4.

The biaxial retardation film 70 is disposed such that the slow axis 71 forms a slow axis angle θ₃ counterclockwise in the Y1 direction with respect to the X direction. The biaxial retardation film 70 is a film used for compensating viewing angle characteristics in the liquid crystal panel 1 of the transverse field system. For the film of in-plane retardation Re=(nₓ-n_{y})·d=270 nm and an Nz coefficient=0.5, nₓ, n_{y} represent refractive indexes in the in-plane direction, n_{z} represents a refractive index in the vertical direction, and d represents a thickness of the biaxial retardation film 70. The Nz coefficient is a coefficient represented by Nz=(nₓ-n_{z})/(nₓ-n_{y}).

The array substrate-side polarizing plate 80 is disposed such that the transmission axis 81 forms a transmission axis angle θ₄ counterclockwise in the Y1 direction with respect to the X direction.

The backlight light 100 is incident on the outer surface of the array substrate-side polarizing plate 80 from a direction of an arrow which is a direction perpendicular to the surface. That is, the incident direction of the backlight light 100 is a direction perpendicular to the X direction and the Y direction.

Here, as the array substrate-side polarizing plate 80 and the color filter-side polarizing plate 90, a general polarizing plate made of triacetyl cellulose (TAC) and polyvinyl alcohol (PVA) are adoptable.

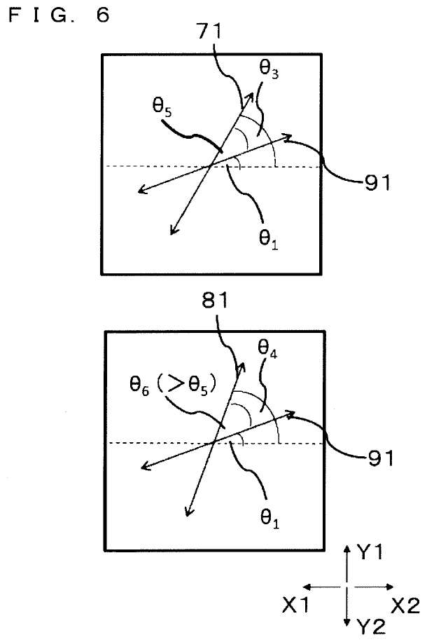

FIG. 6 is a schematic diagram for explaining the features of the liquid crystal panel 1 of this Embodiment. As illustrated in FIG. 6, the slow axis angle θ₃ of the biaxial retardation film 70 has a first deviation angle θ₅ counterclockwise from the absorption axis angle θ₁ of the color filter-side polarizing plate 90. The transmission axis angle θ₄ of the array substrate-side polarizing plate 80 has a second deviation angle θ₆ larger than the first deviation angle θ₅ counterclockwise from the absorption axis angle θ₁ of the color filter-side polarizing plate 90.

The biaxial retardation film 70, the array substrate-side polarizing plate 80, the liquid crystal layer 40, and the color filter-side polarizing plate 90, which are optical components in the liquid crystal panel 1 of this Embodiment, are arranged so as to satisfy the following relationship.

θ₁=θ₂

θ₃=θ₁+θ₅

θ₄=θ₁+θ₆

θ₆=2·θ₅ [Equation 1]

Here, as illustrated in FIG. 6, the X direction is 0°, the direction proceeding counterclockwise from the X direction toward the Yl direction is positive values, and the direction proceeding clockwise from the X direction toward the Y2 direction is negative values.

That is, the absorption axis 91 of the color filter-side polarizing plate 90 is arranged in parallel with the alignment axis 44 of the liquid crystal molecules 42. Further, the slow axis 71 of the biaxial retardation film 70 is arranged so as to form a first deviation angle θ₅ counterclockwise from the absorption axis 91 of the color filter-side polarizing plate 90 or the alignment axis 44 of the liquid crystal molecules 42 in the plane of the liquid crystal panel 1. The transmission axis 81 of the array substrate-side polarizing plate 80 is arranged so as to form a second deviation angle θ₆, which is twice as large as the first deviation angle θ₅ in the same rotation direction as the first deviation angle θ₅ from the absorption axis 91 of the color filter-side polarizing plate 90 or the alignment axis 44 of the liquid crystal molecules 42 in the liquid crystal panel 1 plane.

With such an above-described configuration, the liquid crystal display panel 1 and the liquid crystal display device including thereof of this Embodiment realize a suitable viewing angle characteristic, in a case, while maintaining a favorable visibility from the front direction of the liquid crystal display device, where the liquid crystal display device is viewed from the upper right and left oblique directions, for example, the driver's seat and the passenger seat of a vehicle.

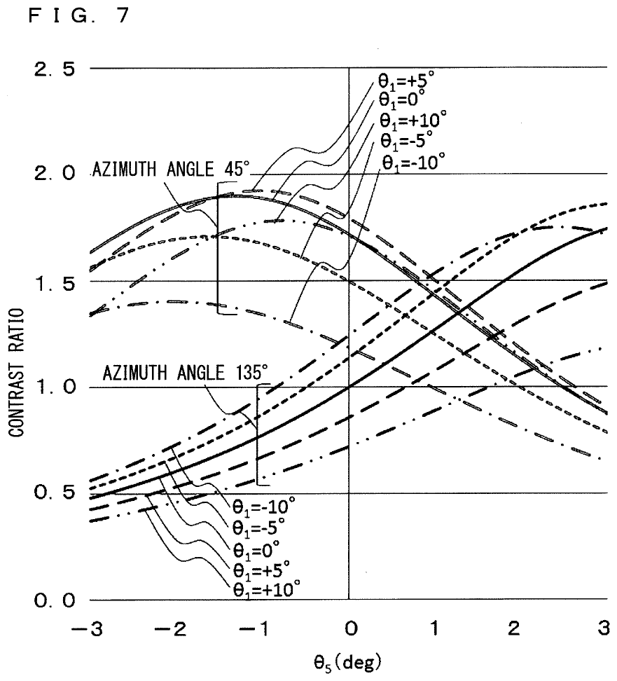

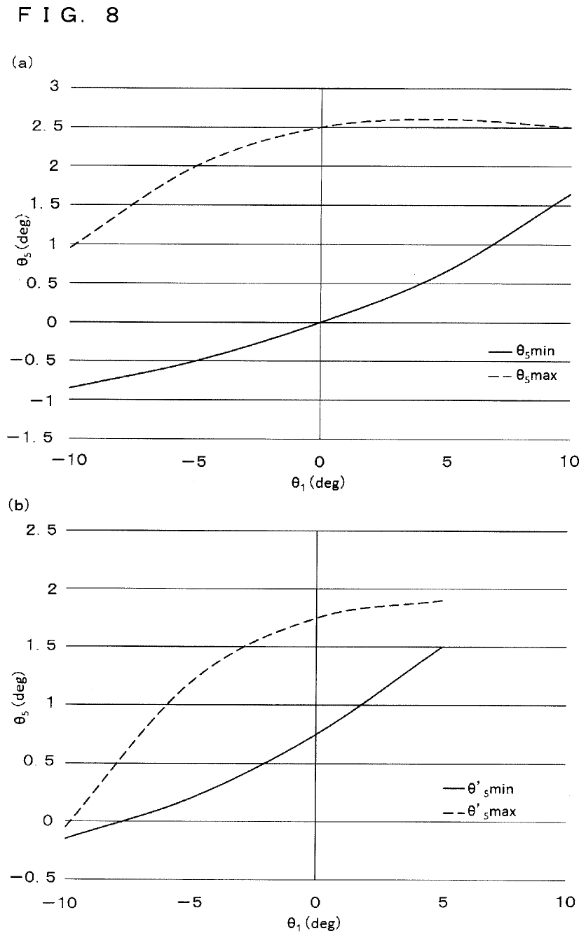

Next, effects obtained with the configuration of this Embodiment will be described. FIG. 7 is a graph illustrating a relationship between a first deviation angle θ₅ which is an angle formed between a slow axis 71 of the biaxial retardation film 70 and an absorption axis 91 of the color filter-side polarizing plate 90 and a contrast ratio in an upper right and left oblique directions. The horizontal axis in FIG. 7 illustrates the first deviation angle θ₅, and the vertical axis illustrates the contrast ratio with a conventional example.

Here, the upper right oblique direction in this Embodiment refers to an azimuth angle of 45° and a polar angle of 45° when the X direction is an azimuth angle of 0°, and the perpendicular direction to the plane of the liquid crystal panel 1 is a polar angle of 0°. The upper left oblique direction in this Embodiment refers to an azimuth angle of 135° and a polar angle of 45° when the X direction is an azimuth angle of 0°, and the perpendicular direction to the plane of the liquid crystal panel 1 is a polar angle of 0°.

FIG. 7 illustrates the relationship between the first deviation angle θ₅ and the contrast ratio when viewed from the upper right and left oblique directions, illustrating when the absorption axis angles θ₁ of the color filter-side polarizing plate 90=−10°, −5°, 0°, +5° and +10°, respectively.

In addition, the contrast ratio on the vertical axis is set to 1 when viewed from the upper left oblique direction in the configuration of the conventional example (when) θ₅=θ₆=0° at the absorption axis angle θ₁=0° as a reference value. The calculation of the contrast ratio can be performed using, for example, a simulator “LCD Master” produced by SHINTECH, Inc.

As illustrated in FIG. 7, for example, by setting 0°<θ₅<2.5° at the absorption axis angle θ₁=0° indicated by the solid line, both the upper left oblique direction and the upper right oblique direction have a configuration exceeding the reference value of 1 for the contrast ratio, that is, visibility and the symmetry in angle of visual field can be improved as compared with the conventional example. In particular, at the absorption axis angle θ₁=0°, at the first deviation angle θ₅=1.25° where the solid lines of azimuth angles 45° and 135° intersect, the contrast ratios when observed from the upper left oblique direction and the upper right oblique direction are substantially the same. Therefore, the liquid crystal display device with improved visibility and the symmetry in angle of visual field when viewed from the upper left oblique direction and the upper right oblique direction compared to the conventional example can be obtained. That is, at the absorption axis angle θ₁=0° indicated by the solid line and within the range of 0<θ₅<2.5, as the first deviation angle θ₅ is brought closer to 1.25°, the visibility from the upper left oblique direction and the upper right oblique direction is improved, and the symmetry in angle of visual field can be further improved.

Similarly, for the other absorption axis angles θ₁, the visibility is improved as compared with the conventional example, within a range of the first deviation angle θ₅ where each curve of the same absorption axis angle θ₁ in azimuth angles 45°, 135°, exceeds 1 which is the reference value of the contrast ratio, and at the first deviation angle θ₅ at which the respective curves of the azimuth angles 45° and 135° intersect, the contrast ratio when observed from the upper left oblique direction and the upper right oblique direction becomes substantially the same; accordingly, a liquid crystal display device having improved symmetry in angle of visual field when viewed from the upper left oblique direction and the upper right oblique direction as compared with the conventional example can be obtained. That is, within the range of the first deviation angle θ₅ where 1, which is the reference value of the contrast ratio is exceeded, as it is brought closer to the first deviation angle θ₅ at which the curves the same absorption axis angle θ₁ in azimuth angles 45° and 135° intersect, the visibility from the upper left oblique direction and the upper right oblique direction is improved, and the symmetry in angle of visual field can be further improved.

Part (a) of FIG. 8 is a graph illustrating a relationship of corresponding absorption axis angle θ₁ in an angle range of the first deviation angle θ₅ in which a contrast ratio of both in the upper left oblique direction and the upper right oblique direction illustrated in FIG. 7 exceeds 1, where θ₅ (solid line) represents the minimum first deviation angle θ₅ min and θ₅ (dotted line) represents the maximum minimum first deviation angle θ₅ max.

As illustrated in part (a) of FIG. 8, in the liquid crystal panel 1 of this Embodiment, by setting the first deviation angle θ₅ and the absorption axis angle θ₁ within the range of θ₅ min<θ₅<θ₅ max, the visibility and the symmetry in angle of visual field when viewed from the upper left oblique direction and the upper right oblique direction can be improved compared to the conventional example. For example, at the absorption axis angle θ₁=0°, as described above, by setting 0°<θ₅<2.5°, both the upper left oblique direction and the upper right oblique direction exceed 1 which is the reference values of the contrast ratio.

By using polynomial approximation for the maximum first deviation angle θ₅ max and the minimum first deviation angle θ₅ min in part (a) of FIG. 8, the following equation can be derived.

θ₅ max=0.0002θ₁³−0.0078θ₁²+0.0542θ₁+2.5000

θ₅ min=0.0001θ₁³+0.0039θ₁²+0.1117θ₁ [Equation 2]

In the liquid crystal panel 1 of this Embodiment, by setting the first deviation angle θ₅ and the absorption axis angle θ₁ within the range of θ₅ min<θ₅<θ₅ max so as to satisfy the above approximation, the visibility and the symmetry in angle of visual field when viewed from the upper left oblique direction and the upper right oblique direction are improved compared to the conventional example.

Although the visibility is improved more than the conventional example with the range of the first deviation angle θ₅ represented by the above approximation, from the view point of the symmetry in angle of visual field, some variation in the contrast ratio remains in the upper left oblique direction and the upper right oblique direction around the minimum first deviation angle θ₅ min and the maximum first deviation angle θ₅ max represented by the above approximation.

As compared with part (a) of FIG. 8, part (b) of FIG. 8 is a graph illustrating a relationship between the first deviation angle θ₅ and the absorption axis angle θ₁ when the symmetry in angle of visual field in the upper left oblique direction and the upper right oblique direction is improved and is a graph illustrating a relationship of corresponding absorption axis angle θ₁ in an angle range of the first deviation angle θ₅ in which a contrast ratio of both in the upper left oblique direction and the upper right oblique direction illustrated in FIG. 7 exceeds 1.2, where the minimum first deviation angle θ₅ is expressed as θ′₅ min (solid line) and the maximum minimum first deviation angle θ₅ is expressed as θ′₅ max (dotted line).

As illustrated in part (b) of FIG. 8, by setting 0.75≤θ₅≤1.75 at the absorption axis angle θ₁=0° the upper left oblique direction and the upper right oblique direction have a configuration exceeding the reference value of 1.2 for the contrast ratio; therefore, compared with part (a) of FIG. 8, the visibility in the upper left oblique direction and the upper right oblique direction is improved, and the symmetry in angle of visual field in the upper left oblique direction and the upper right oblique direction is further improved.

As in the same with part (a) of FIG. 8, by using polynomial approximation for the maximum first deviation angle θ′₅ max and the minimum first deviation angle θ′₅ min in part (b) of FIG. 8, the following equation can be derived.

θ′₅ max=0.0004θ₁³−0.0080θ₁²+0.0600θ₁+1.7500

θ′₅ min=0.0040θ₁²+0.1300θ₁+0.7500 [Equation 3]

In the liquid crystal panel 1 of this Embodiment, by setting the first deviation angle θ₅ and the absorption axis angle θ₁ within the range of θ′₅ min<θ₅<θ′₅ max so as to satisfy the above approximation, not only the visibility and the symmetry in angle of visual field when viewed from the upper left oblique direction and the upper right oblique direction are improved compared to the conventional example but also the visibility and the viewing angle symmetry from the upper left oblique direction and the upper right oblique direction can be improved as compared to that of part (a) of FIG. 8.

In particular, as illustrated in part (b) of FIG. 8, by setting the deviation angle θ₅ and the absorption axis angle θ₁ within the range satisfying θ′₅ min<θ₅<θ′₅ max in the counterclockwise direction, where the first deviation angle θ₅ is an angle larger than 0°, the visibility and the symmetry in angle of visual field are further improved as compared to the conventional example and part (a) in FIG. 8.

Next, in this Embodiment, in order to achieve the effect of this Embodiment, the importance of controlling the axis angles of the biaxial retardation film 70, the array substrate-side polarizing plate 80, the color filter-side polarizing plate 90, and the liquid crystal molecules 42 will be described.

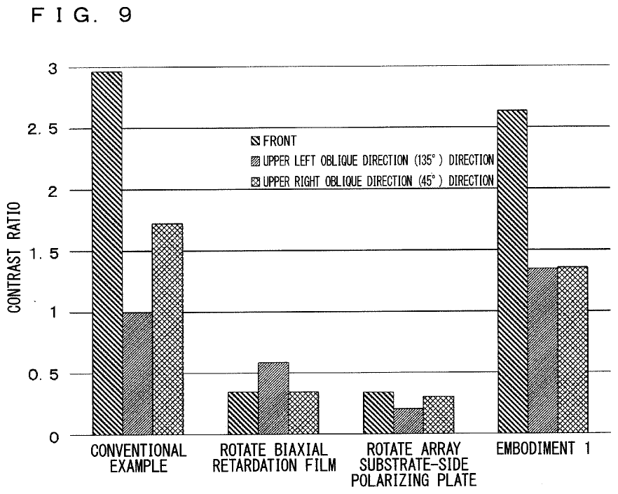

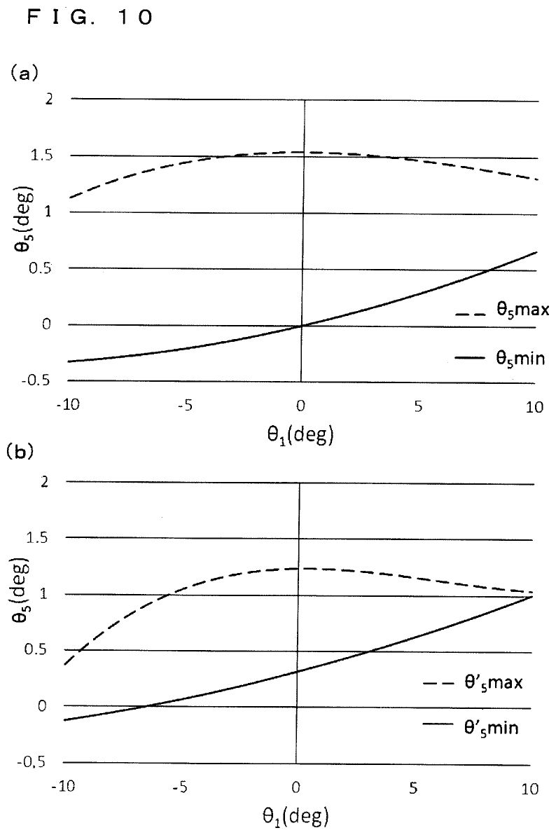

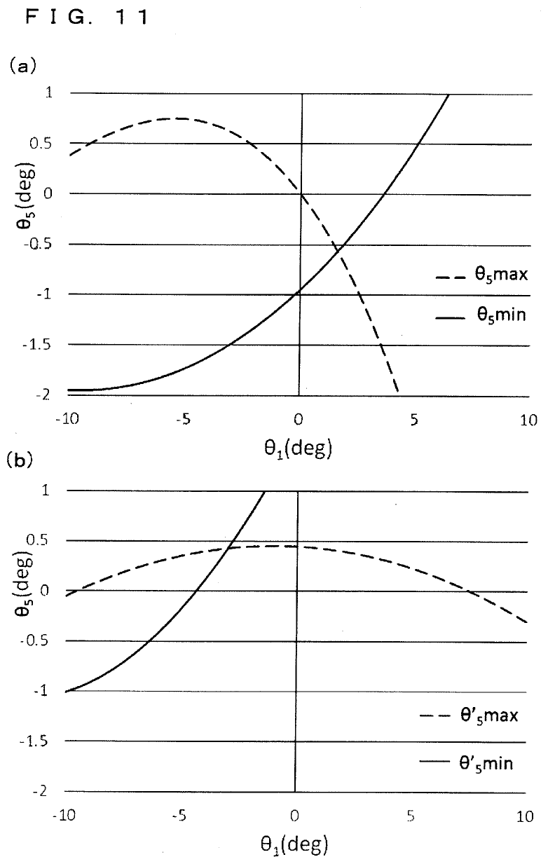

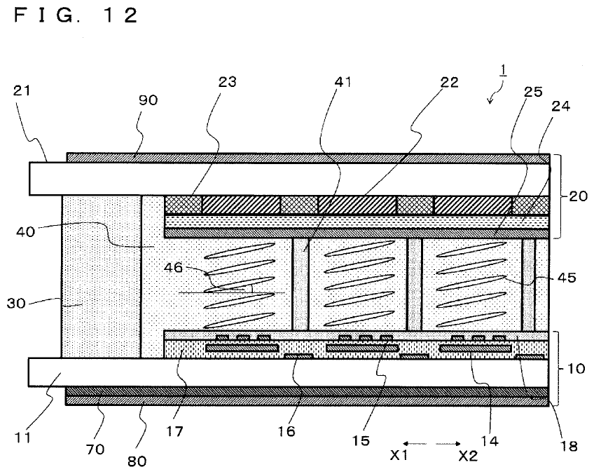

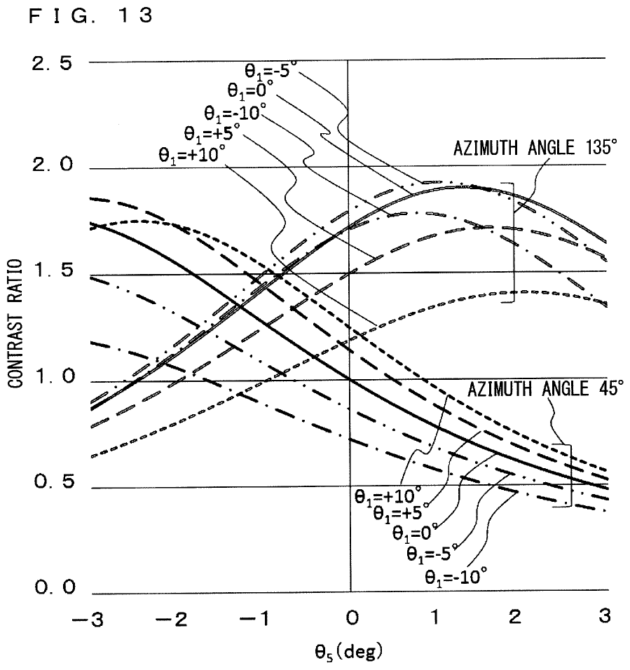

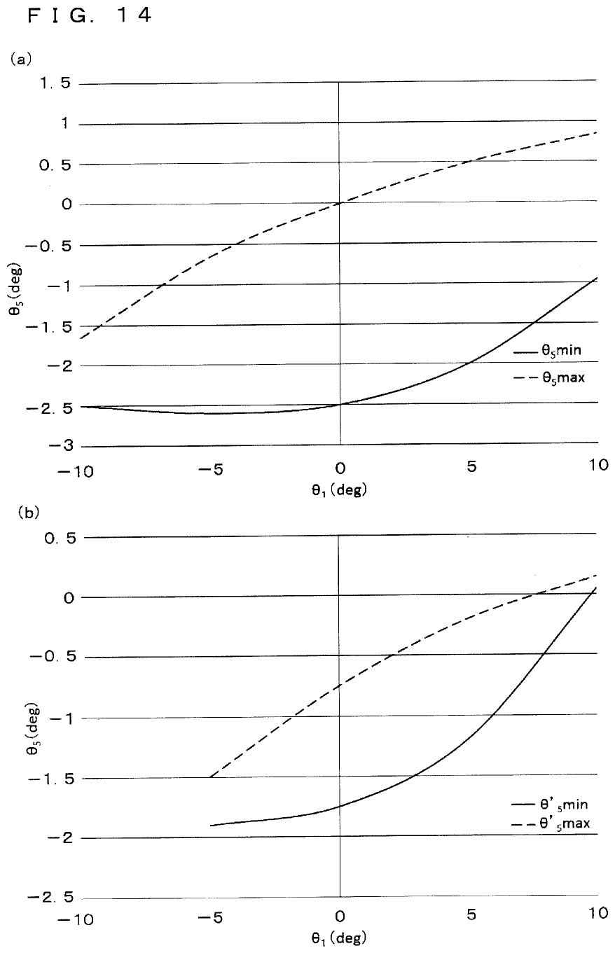

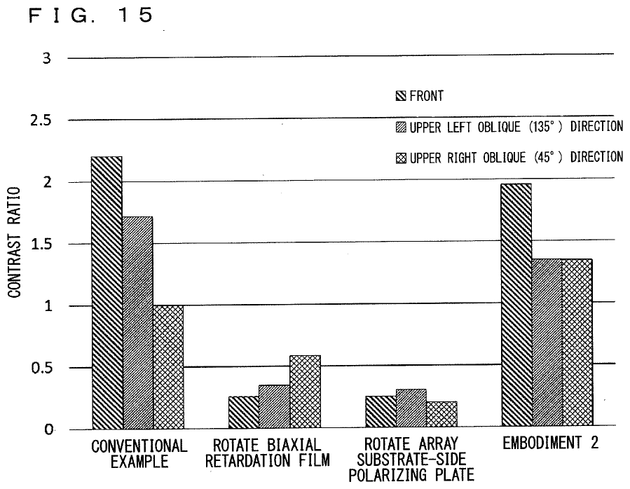

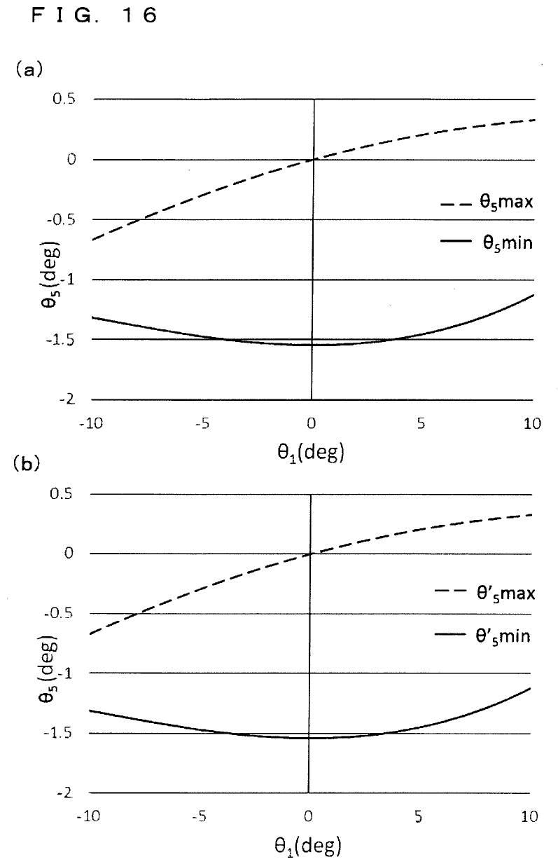

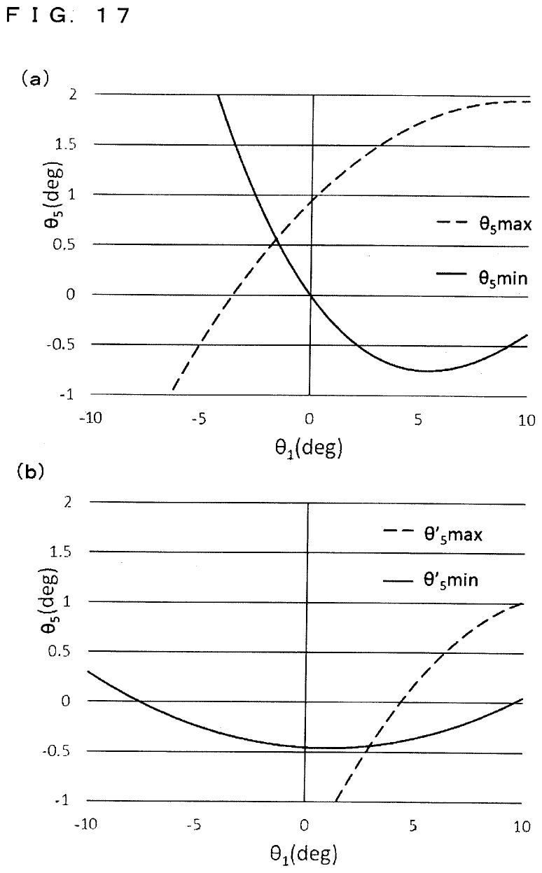

FIG. 9 is a graph illustrating a comparison in which the conventional example) (θ₅=θ₆=0°, a configuration in which only the slow axis 71 of the biaxial retardation film 70 is shifted (θ₅=1.25°, θ₆=0°, a configuration in which only the transmission axis 81 of the array substrate-side polarizing plate 80 is shifted (θ₅=0°, θ₆=2.5°), and the configuration of this Embodiment (θ₅=1.25°, θ₆=2.5°) are compared with respect to the contrast ratio when observed from the upper left oblique direction, the upper right oblique direction, and the front direction. As in FIG. 7, the contrast ratio on the vertical axis is set to 1 when viewed from the upper left oblique direction in the configuration of the conventional example (when θ₅=θ₆=0°) at the absorption axis angle θ₁=0° as a reference value.

As illustrated in FIG. 9, in the conventional example, the symmetry in angle of visual field in the upper left oblique direction and the upper right oblique direction is low, for example, the contrast ratio when observed from the upper left oblique direction is lower than that of this Embodiment by 35%. And when either the slow axis 71 of biaxial retardation film 70 or transmission axis 81 of array substrate-side polarizing plate 80 is shifted, the contrast ratio in the upper left oblique direction, the upper right oblique direction, and the front direction tends to decrease in both cases where only the first deviation angle θ₅ is shifted and only the second deviation angle θ₆ is shifted as compared to this Embodiment.

Meanwhile, the contrast ratios when observed from the upper left oblique direction and the contrast ratios when observed from the upper right oblique direction indicate substantially the same value in this Embodiment; therefore, the liquid crystal display device with excellent symmetry in angle of visual field is ensured. Further, when either the slow axis 71 of biaxial retardation film 70 or transmission axis 81 of array substrate-side polarizing plate 80 is shifted, the contrast ratio when viewed from the front direction is reduced by about 90%, while the reduction is only about by 10% in this Embodiment; therefore, improvement in the visibility from the upper oblique direction is ensured while maintaining the visibility from the front direction in high value.

As described above, the liquid crystal display panel 1 and the liquid crystal display device including thereof of this Embodiment improve the visibility and the symmetry in angle of visual field and realize a suitable viewing angle characteristic, in a case, while maintaining a favorable visibility from the front direction of the liquid crystal display device, where the liquid crystal display device is viewed from the upper right and left oblique directions, for example, the driver's seat and the passenger seat of a vehicle.

In this Embodiment, although the relationship between the first deviation angle θ₅ and the second deviation angle θ₆ is set to θ₆=2·θ₅, it is not necessarily limited thereto. The second deviation angle θ₆ may only be set to have an angle larger than the first deviation angle θ₅, and needless to say, with such a setting, the same effect as the effect described in this Embodiment can be achieved. In such a case, the approximation described with reference to FIG. 8 is also set as appropriate, and the predetermined first deviation angle θ₅ and absorption axis angle θ₁ are set.

For example, when the relationship between the first deviation angle θ₅ and the second deviation angle θ₆ is set to θ₆=1.5·θ₅, with part (a) of FIG. 10 which is a graph illustrating a relationship of corresponding absorption axis angle θ₁ in an angle range of the first deviation angle θ₅ in which a contrast ratio of both in the upper left oblique direction and the upper right oblique direction exceeds 1, where the minimum first deviation angle θ₅ is expressed as θ₅ min (solid line) and the maximum first deviation angle θ₅ is expressed as θ₅ max (dotted line), and by using polynomial approximation for the maximum first deviation angle θ₅ max and the minimum first deviation angle θ₅ min, the following equation can be derived.

θ₅ max=0.0001θ₁³−0.0032θ₁²−0.0007θ₁+1.54

θ₅ min=0.0017θ₁²+0.05θ₁ [Equation 4]

Further, with part (b) of FIG. 10 which is a graph illustrating a relationship of corresponding absorption axis angle θ₁ in an angle range of the first deviation angle θ₅ in which a contrast ratio of both in the upper left oblique direction and the upper right oblique direction exceeds 1.2, where the minimum first deviation angle θ₅ is expressed as θ′₅ min (solid line) and the maximum first deviation angle θ₅ is expressed as θ′₅ max (dotted line), and by using polynomial approximation for the maximum first deviation angle θ′₅ max and the minimum first deviation angle θ′₅ min, the following equation can be derived.

θ′₅ max=0.0003θ₁³−0.0053θ₁²+0.0033θ₁+1.24

θ′₅ min=0.0012θ₁²+0.0563θ₁+0.32 [Equation 5]

Further, when the relationship between the first deviation angle θ₅ and the second deviation angle θ₆ is set to θ₆=2.5·θ₅, with part (a) of FIG. 11 which is a graph illustrating a relationship of corresponding absorption axis angle θ₁ in an angle range of the first deviation angle θ₅ in which a contrast ratio of both in the upper left oblique direction and the upper right oblique direction exceeds 1, where the minimum first deviation angle θ₅ is expressed as θ₅ min (solid line) and the maximum first deviation angle θ₅ is expressed as θ₅ max (dotted line), and by using polynomial approximation for the maximum first deviation angle θ₅ max and the minimum first deviation angle θ₅ min, the following equation can be derived.

θ₅ max=−0.0008θ₁³−0.0342θ₁²=0.2998θ₁

θ₅ min=0.0001θ₁³+0.013θ₁²+0.2202θ₁−0.95 [Equation 6]

Further, with part (b) of FIG. 11 which is a graph illustrating a relationship of corresponding absorption axis angle θ₁ in an angle range of the first deviation angle θ₅ in which a contrast ratio of both in the upper left oblique direction and the upper right oblique direction exceeds 1.2, where the minimum first deviation angle θ₅ is expressed as θ′₅ min (solid line) and the maximum first deviation angle θ₅ is expressed as θ′₅ max (dotted line), and by using polynomial approximation for the maximum first deviation angle θ′₅ max and the minimum first deviation angle θ′₅ min, the following equation can be derived.

θ′₅ max=−0.0062θ₁²−0.0125θ₁+0.45

θ′₅ min=0.0187θ₁²+0.4475θ₁+1.58

That is, not only may θ₆ be set to twice θ₅ but also θ₆ may be set in a range of 1.5 times or more to 2.5 times θ₅ or less.

Further, in this Embodiment, although a film having Re=270 nm and Nz coefficient=0.5 has been described as an example of the biaxial retardation film 70, this is an example, a biaxial retardation film 70 of a type exhibiting a similar viewing angle compensation effect is adoptable.

### Embodiment 2

The liquid crystal panel 1 provided in the liquid crystal display device according to Embodiment 2 of the present invention is different from Embodiment 1 in the pretilt angle 46 of the liquid crystal molecules 45 of the liquid crystal layer 40. Therefore, the configuration of the absorption axis angle θ₁ of the color filter-side polarizing plate 90, the alignment axis angle θ₂ of the liquid crystal molecules 45, the slow axis angle θ₃ of the biaxial retardation film 70, and the transmission axis angle θ₄ of the array substrate-side polarizing plate 80 differs accordingly. Except for this point, other parts are configured in the same manner as the liquid crystal panel 1 of Embodiment 1.

FIG. 12 is a schematic cross-sectional view of the liquid crystal panel 1 according to this Embodiment taken along section line AA in FIG. 1. As described above, the pretilt angle 46 of the liquid crystal molecules 45 of the liquid crystal layer 40 is different from that in Embodiment 1, and the pretilt angle 46 of the liquid crystal molecules 45 is set such that the liquid crystal molecules 45 are separated from the array substrate 10 in the X2 direction on the array substrate 10 side. On the color filter substrate 20 side, the pretilt angle 46 of the liquid crystal molecules 45 is set so that the liquid crystal molecules 45 are separated from the color filter substrate 20 in the X1 direction. That is, the pretilt angle 46 of the liquid crystal molecules 42 is an angle formed counterclockwise, from the surface of the array substrate 10, in the direction from the array substrate 10 toward the color filter substrate 20 on the array substrate 10 side, and on the color filter substrate 20 side, the pretilt angle 43 is an angle formed counterclockwise, from the surface of the color filter substrate 20, in the direction from the color filter substrate 20 toward the array substrate 10. Here, the pretilt angle 46 is, for example, 1.0° to 2.0°.

The biaxial retardation film 70, the array substrate-side polarizing plate 80, the liquid crystal layer 40, and the color filter-side polarizing plate 90, which are optical components in the liquid crystal panel 1 of this Embodiment, are arranged in the same relationship as illustrated in Embodiment 1. That is, the following relations is satisfied wherein θ₁ represents the absorption axis angle of the color filter-side polarizing plate 90, θ₂ represents the alignment axis angle of the liquid crystal molecules 45, θ₃ represents the slow axis angle of the biaxial retardation film 70, θ₄ represents the transmission axis angle of the array substrate-side polarizing plate 80, θ₅ represents the angle between the slow axis 71 of the biaxial retardation film 70 and the absorption axis 91 of the color filter-side polarizing plate 90, and θ₆ represents the angle between the transmission axis 81 of the array substrate-side polarizing plate 80 and the absorption axis 91 of the color filter-side polarizing plate 90.

θ₁=θ₂

θ₃=θ₁+θ₅

θ₄=θ₁+θ₆

θ₆2·θ₅ [Equation 8]

Here, as illustrated in FIG. 6, the X direction is 0°, the direction proceeding counterclockwise from the X direction toward the Y1 direction is positive values, and the direction proceeding clockwise from the X direction toward the Y2 direction is negative values.

With such an above-described configuration, as in Embodiment 1, the liquid crystal display panel and the liquid crystal display device including thereof of this Embodiment realize a suitable viewing angle characteristic, in a case, while maintaining a favorable visibility from the front direction of the liquid crystal display device, where the liquid crystal display device is viewed from the upper right and left oblique directions, for example, the driver's seat and the passenger seat of a vehicle.

Next, effects obtained with the configuration of this Embodiment will be described. FIG. 13 is a graph illustrating the relationship between a first deviation angle θ₅ which is an angle formed between a slow axis 71 of the biaxial retardation film 70 and an absorption axis 91 of the color filter-side polarizing plate 90 and a contrast ratio in an upper right and left oblique directions. The horizontal axis in FIG. 13 illustrates the first deviation angle θ₅, and the vertical axis illustrates the contrast ratio with a conventional example.

Here, as in Embodiment 1, for the definition of the upper right and left oblique directions in this Embodiment, the upper right oblique direction refers to an azimuth angle of 45° and a polar angle of 45° when the X direction is an azimuth angle of 0°, and the perpendicular direction to the plane of the liquid crystal panel 1 is a polar angle of 0°, and the upper left oblique direction refers to an azimuth angle of 135° and a polar angle of 45° when the X direction is an azimuth angle of 0°, and the perpendicular direction to the plane of the liquid crystal panel 1 is a polar angle of 0°.

FIG. 13 illustrates the relationship between the first deviation angle θ₅ and the contrast ratio when viewed from the obliquely upward in the left and right direction, illustrating when the absorption axis angles θ₁ of the color filter-side polarizing plate 90=−10°, −5°, 0°, +5° and +10°, respectively. As in the same with Embodiment 1, the reference value of the contrast ratio on the vertical axis is set to 1 when viewed from the upper left oblique direction in the configuration of the conventional example (when θ₅=θ₆=0°) at the absorption axis angle θ₁=0°. The calculation of the contrast ratio can be performed using, for example, a simulator “LCD Master” produced by SHINTECH, Inc.

As illustrated in FIG. 13, for example, by setting −2.5°<θ₅<0° at the absorption axis angle θ₁=0° indicated by the solid line, both the upper left oblique direction and the upper right oblique direction have a configuration exceeding the reference value of 1 for the contrast ratio, that is, visibility and symmetry in angle of visual field can be improved as compared with the conventional example. In particular, at the absorption axis angle θ₁=0°, at the first deviation angle θ₅=−1.25° where the solid lines of azimuth angles 45° and 135° intersect, the contrast ratios when observed from the upper left oblique direction and the upper right oblique direction are substantially the same. Therefore, the liquid crystal display device with improved visibility and the symmetry in angle of visual field when viewed from the upper left oblique direction and the upper right oblique direction compared to the conventional example can be obtained. That is, at the absorption axis angle θ₁=0° indicated by the solid line and within the range of −2.5<θ₅<0, as the first deviation angle θ₅ is brought closer to −1.25°, the visibility from the upper left oblique direction and the upper right oblique direction is improved, and the symmetry in angle of visual field can be further improved.

Similarly, for the other absorption axis angles θ₁, the visibility is improved as compared with the conventional example, within a range of the first deviation angle θ₅ where each curve of the same absorption axis angle θ₁ in azimuth angles 45°, 135° exceeds 1 which is the reference value of the contrast ratio, and at the first deviation angle θ₅ at which the respective curves of the azimuth angles 45° and 135° intersect, the contrast ratio when observed from the upper left oblique direction and the upper right oblique direction becomes substantially the same; accordingly, a liquid crystal display device having improved symmetry in angle of visual field when viewed from the upper left oblique direction and the upper right oblique direction as compared with the conventional example can be obtained. That is, within the range of the first deviation angle θ₅ where 1, which is the reference value of the contrast ratio is exceeded, as it is brought closer to the first deviation angle θ₅ at which the curves the same absorption axis angle θ₁ in azimuth angles 45° and 135° intersect, the visibility from the upper left oblique direction and the upper right oblique direction is improved, and the symmetry in angle of visual field can be further improved.

Here, in this Embodiment, the first deviation angle θ₅ has a negative value as compared with that of Embodiment 1. That is, the first deviation angle θ₅ indicates an angle formed in the Y2 direction from the X direction, that is, in the clockwise direction.

Part (a) of FIG. 14 is a graph illustrating a relationship of corresponding absorption axis angle θ₁ in an angle range of the first deviation angle θ₅ in which a contrast ratio of both in the upper left oblique direction and the upper right oblique direction illustrated in FIG. 13 exceeds 1, where the minimum first deviation angle θ₅ is expressed as θ₅ min (solid line) and the maximum first deviation angle θ₅ is expressed as θ₅ max (dotted line)

As illustrated in part (a) of FIG. 14, in the liquid crystal panel 1 of this Embodiment, by setting the first deviation angle θ₅ and the absorption axis angle θ₁ within the range of θ₅ min<θ₅<θ₅ max, the visibility and the symmetry in angle of visual field when viewed from the upper left oblique direction and the upper right oblique direction can be improved compared to the conventional example. For example, at the absorption axis angle θ₁=0°, as described above, by setting −2.5°<θ₅<0, both the upper left oblique direction and the upper right oblique direction exceed 1 which is the reference values of the contrast ratio, and in such a configuration, the visibility and the symmetry in angle of visual field when viewed from the upper left oblique direction and the upper right oblique direction can be improved compared to the conventional example.

By using polynomial approximation for the maximum first deviation angle θ₅ max and the minimum first deviation angle θ₅ min in part (a) of FIG. 14, the following equation can be derived.

θ₅ max=0.0001θ₁³−0.0039θ₁²+0.1117θ₁

θ₅ min=0.0002θ₁³+0.0078θ₁²+0.0542θ₁−2.5000 [Equation 9]

As illustrated in part (a) of FIG. 14, in the liquid crystal panel 1 of this Embodiment, by setting the first deviation angle θ₅ and the absorption axis angle θ₁ within the range of θ₅ min<θ₅<θ₅ max so as to satisfy the above described approximation, the visibility and the symmetry in angle of visual field when viewed from the upper left oblique direction and the upper right oblique direction can be improved compared to the conventional example.

However, as in Embodiment 1, for this Embodiment, the visibility is improved more than the conventional example with the range of the first deviation angle θ₅ represented by the above approximation, from the view point of the symmetry in angle of visual field, some variation in the contrast ratio remains in the upper left oblique direction and the upper right oblique direction around the minimum first deviation angle θ₅ min and the maximum first deviation angle θ₅ max represented by the above approximation.

As compared with part (a) of FIG. 14, part (b) of FIG. 14 is a graph illustrating a relationship between the first deviation angle θ₅ and the absorption axis angle θ₁ when the symmetry in angle of visual field in the upper left oblique direction and the upper right oblique direction is improved and is a graph illustrating a relationship of corresponding absorption axis angle θ₁ in an angle range of the first deviation angle θ₅ in which a contrast ratio of both in the upper left oblique direction and the upper right oblique direction illustrated in FIG. 13 exceeds 1.2, where the minimum first deviation angle θ₅ is expressed as θ₅ min (solid line) and the maximum first deviation angle θ₅ is expressed as θ₅ max (dotted line).

As illustrated in part (b) of FIG. 14, by setting −1.75≤θ₅≤−0.75 at the absorption axis angle θ₁=0° the upper left oblique direction and the upper right oblique direction have a configuration exceeding the reference value of 1.2 for the contrast ratio; therefore, compared with part (a) of FIG. 14, the visibility in the upper left oblique direction and the upper right oblique direction is improved, and the symmetry in angle of visual field in the upper left oblique direction and the upper right oblique direction is further improved.

As in the same with part (a) of FIG. 14, by using polynomial approximation for the maximum first deviation angle θ′₅ max and the minimum first deviation angle θ′₅ min in part (b) of FIG. 14, the following equation can be derived.

θ′₅ max=−0.0040θ₁²+0.1300θ₁−0.7500

θ′₅ min=0.0004θ₁³+0.0080θ₁²+0.0600θ₁−1.7500 [Equation 10]

As illustrated in part (b) of FIG. 14, in the liquid crystal panel 1 of this

Embodiment, by setting the first deviation angle θ₅ and the absorption axis angle θ₁ within the range of θ′₅ min<θ₅<θ′₅ max so as to satisfy the above described approximation, not only the visibility and the symmetry in angle of visual field when viewed from the upper left oblique direction and the upper right oblique direction can be improved compared to the conventional example, but also, compared with part (a) in FIG. 14, the visibility and the symmetry in angle of visual field can be further improved.

In particular, as illustrated in part (b) of FIG. 14, by setting the first deviation angle θ₅ and the absorption axis angle θ₁ within the range satisfying θ′₅ min<θ₅<θ′₅ max in the clockwise direction, that is, where the first deviation angle θ₅ takes a negative value, or, is an angle larger than 0°, the visibility and the symmetry in angle of visual field are further improved as compared to the conventional example and part (a) in FIG. 14.

Next, in this Embodiment, in order to achieve the effect of this Embodiment, the importance of controlling the axis angles of the biaxial retardation film 70, the array substrate-side polarizing plate 80, the color filter-side polarizing plate 90, and the liquid crystal molecules 42 will be described.

FIG. 15 is a graph illustrating a comparison in which the conventional example) (θ₅=θ₆=0°, a configuration in which only the slow axis 71 of the biaxial retardation film 70 is shifted (θ₅=−1.25°, θ₆=0°), a configuration in which only the transmission axis 81 of the array substrate-side polarizing plate 80 is shifted (θ₅=0°θ₆,=−2.5°), and a graph comparing the configuration of this Embodiment (θ₅=−1.25°, θ₆=−2.5°) are compared with respect to the contrast ratio when observed from the upper left oblique direction, the upper right oblique direction, and the front direction. As in FIG. 13, the contrast ratio on the vertical axis is set to 1 when viewed from the upper left oblique direction in the configuration of the conventional example (when θ₅=θ₆=0°) at the absorption axis angle θ₁=0° as a reference value.

As illustrated in FIG. 15, in the conventional example, the symmetry in angle of visual field in the upper left oblique direction and the upper right oblique direction is low, for example, the contrast ratio when observed from the upper left oblique direction is lower than that of this Embodiment by 35%. And when either the slow axis 71 of biaxial retardation film 70 or transmission axis 81 of array substrate-side polarizing plate 80 is shifted, the contrast ratio in the upper left oblique direction, the upper right oblique direction, and the front direction tends to decrease in both cases where only the first deviation angle θ₅ is shifted and the second deviation angle θ₆ is shifted as compared to Embodiment 2.

Meanwhile, the contrast ratios when observed from the upper left oblique direction and the contrast ratios when observed from the upper right oblique direction indicate the same value in this Embodiment; therefore, the liquid crystal display device with excellent symmetry in angle of visual field is ensured. Further, when either the slow axis 71 of biaxial retardation film 70 or transmission axis 81 of array substrate-side polarizing plate 80 is shifted, the contrast ratio when viewed from the front direction is reduced by about 90%, while the reduction is only about by 10% in this Embodiment; therefore, improvement in the visibility from the upper oblique direction is ensured while maintaining the visibility from the front direction in high value.

As described above, the liquid crystal panel and the liquid crystal display device including thereof of this Embodiment improve the visibility and the symmetry in angle of visual field and realize a suitable viewing angle characteristic, in a case, while maintaining a favorable visibility from the front direction of the liquid crystal display device, where the liquid crystal display device is viewed from the upper right and left oblique directions, for example, the driver's seat and the passenger seat of a vehicle.

In this Embodiment, although the relationship between the first deviation angle θ₅ and the second deviation angle θ₆ is set to θ₆=2·θ₅, it is not necessarily limited thereto. When the second deviation angle θ₆ is set to have an angle larger than the first deviation angle θ₅, and needless to say, with such a setting, the same effect as the effect described in this Embodiment can be achieved. In such a case, the approximation described with reference to FIG. 14 is also set as appropriate, and the predetermined first deviation angle θ₅ and absorption axis angle θ₁ are set.

For example, when the relationship between the first deviation angle θ₅ and the second deviation angle θ₆ is set to θ₆=1.5·θ₅, with part (a) of FIG. 16 which is a graph illustrating a relationship of corresponding absorption axis angle θ₁ in an angle range of the first deviation angle θ₅ in which a contrast ratio of both in the upper left oblique direction and the upper right oblique direction exceeds 1, where the minimum first deviation angle θ₅ is expressed as θ₅ min (solid line) and the maximum first deviation angle θ₅ is expressed as θ₅ max (dotted line), and by using polynomial approximation for the maximum first deviation angle θ₅ max and the minimum first deviation angle θ₅ min, the following equation can be derived.

θ₅ max=−0.0017θ₁²+0.05θ₁

θ₅ min=0.0001θ₁³+0.0032θ₁²−0.0007θ₁−1.54 [Equation 11]

Further, with part (b) of FIG. 16 which is a graph illustrating a relationship of corresponding absorption axis angle θ₁ in an angle range of the first deviation angle θ₅ in which a contrast ratio of both in the upper left oblique direction and the upper right oblique direction exceeds 1.2, where the minimum first deviation angle θ₅ is expressed as θ′₅ min (solid line) and the maximum first deviation angle θ₅ is expressed as θ′₅ max (dotted line), and by using polynomial approximation for the maximum first deviation angle θ′₅ max and the minimum first deviation angle θ′₅ min, the following equation can be derived.

θ′₅ max=−0.0012θ₁²+0.0563θ₁−0.32

θ′₅ min=0.0003θ₁³+0.0053θ₁²+0.0033θ₁−1.24 [Equation 12]

Further, when the relationship between the first deviation angle θ₅ and the second deviation angle θ₆ is set to θ₆=2.5·θ₅, with part (a) of FIG. 17 which is a graph illustrating a relationship of corresponding absorption axis angle θ₁ in an angle range of the first deviation angle θ₅ in which a contrast ratio of both in the upper left oblique direction and the upper right oblique direction exceeds 1, where the minimum first deviation angle θ₅ is expressed as θ₅ min (solid line) and the maximum first deviation angle θ₅ is expressed as θ₅ max (dotted line), and by using polynomial approximation for the maximum first deviation angle θ₅ max and the minimum first deviation angle θ₅ min, the following equation can be derived.

θ₅ max=0.0001θ₁³−0.013θ₁²+0.2202θ₁+0.95

θ₅ min=−0.0008θ₁³+0.0342θ₁²−0.2998θ₁ [Equation 13]

Further, with part (b) of FIG. 17 which is a graph illustrating a relationship of corresponding absorption axis angle θ₁ in an angle range of the first deviation angle θ₅ in which a contrast ratio of both in the upper left oblique direction and the upper right oblique direction exceeds 1.2, where the minimum first deviation angle θ₅ is expressed as θ′₅ min (solid line) and the maximum first deviation angle θ₅ is expressed as θ′₅ max (dotted line), and by using polynomial approximation for the maximum first deviation angle θ′₅ max and the minimum first deviation angle θ′₅ min, the following equation can be derived.

θ′₅ max=−0.0187θ₁²+0.4475θ₁−1.58

θ′₅ min=0.0062θ₁²−0.0125θ₁−0.45 [Equation 14]

That is, not only may θ₆ be set to twice θ₅ but also θ₆ may be set in a range of 1.5 times or more to 2.5 times or less of θ₅.

It should be noted that Embodiments of the present invention can be arbitrarily combined and can be appropriately modified or omitted without departing from the scope of the invention.

Furthermore, the present invention is not limited to above-described Embodiments, and various modifications can be made without departing from the scope of the invention in the implementation stage. Further, above Embodiments include inventions at various stages, and various inventions can be extracted by appropriately combining a plurality of disclosed constituent requirements.

### EXPLANATION OF REFERENCE SIGNS

1. liquid crystal panel, 10. array substrate, 11, 21. transparent substrate, 12. gate electrode, 13. source electrode, 14. common electrode, 15. pixel electrode, 16. TFT (switching element), 17. insulating film, 18, 25. alignment film, 20. color filter substrate (counter substrate), 22. color filter, 23. light shielding layer, 24. overcoat film, 30. sealing material, 31. semiconductor channel layer, 32. drain electrode, 40. liquid crystal layer, 41. columnar spacer, 42, 45. liquid crystal molecule, 43, 46. pretilt angle, 44. alignment axis, 50. display area, 60. frame area, 61. scanning signal drive circuit, 62. display signal drive circuit, 70. biaxial retardation film, 71. slow axis, 80. array substrate-side polarizing plate (first polarizing plate), 81. transmission axis, 90. color filter-side polarizing plate (second polarizing plate), 91. absorption axis, θ₁. absorption axis angle, θ₂. alignment axis angle, θ₃. slow axis angle, θ₄. transmission axis angle, θ₅. first deviation angle, θ6. second deviation angle.

1. A liquid crystal panel comprising: an array substrate having a plurality of switching elements arranged in a matrix on a transparent substrate; a counter substrate arranged opposite to the array substrate; and a liquid crystal layer sandwiched between the array substrate and the counter substrate and composed of liquid crystal molecules, wherein
the array substrate includes a biaxial retardation film provided on an opposite side of a surface of the transparent substrate on which the switching elements are formed, and a first polarizing plate provided by lamination on the biaxial retardation film,
the counter substrate includes a second polarizing plate provided on a side opposite to a side facing the liquid crystal layer,
an absorption axis of the second polarizing plate is parallel to an alignment axis of the liquid crystal molecules,
the biaxial retardation film is arranged such that the slow axis of the biaxial retardation film forms a first angle formed counterclockwise with the absorption axis or formed clockwise with the alignment axis in a plane of the liquid crystal panel, and
the first polarizing plate is arranged such that the transmission axis of the first polarizing plate forms a second angle larger than the first angle from the absorption axis or the alignment axis in the same direction as the first angle in the plane of the liquid crystal panel.

2. The liquid crystal panel according to claim 1, wherein
the liquid crystal molecules has a pretilt angle which is an angle formed clockwise, from a surface of the array substrate, from the array substrate toward the counter substrate on an array substrate side, and on a counter substrate side, the pretilt angle is an angle formed clockwise, from a surface of the counter substrate, from the counter substrate toward the array substrate, and
the biaxial retardation film is arranged such that the slow axis of the biaxial retardation film forms a first angle from the absorption axis or the alignment axis counterclockwise in the plane of the liquid crystal panel.

3. The liquid crystal panel according to claim 1, wherein
the liquid crystal molecules have a pretilt angle which is an angle formed counterclockwise, from a surface of the array substrate, from the array substrate toward the counter substrate on an array substrate side, and on a counter substrate side, the pretilt angle is an angle formed counterclockwise, from a surface of the counter substrate, from the counter substrate toward the array substrate, and
the biaxial retardation film is arranged such that the slow axis of the biaxial retardation film forms a first angle from the absorption axis or the alignment axis clockwise in the plane of the liquid crystal panel.

4. The liquid crystal panel according to claims 1, wherein the second angle is twice as large as the first angle.

5. The liquid crystal panel according to claim 4, wherein
the first angle has a value larger than θ min and smaller than θ max under a condition of
θ max=0.0004θ³−0.0080θ²+0.060θ+1.7500
θ min=0.0040θ²+0.1300θ+0.7500
wherein θ represents an angle formed with the absorption axis of the second polarizing plate and a horizontal direction within a surface of the liquid crystal panel with respect to a display screen of the liquid crystal panel.

6. The liquid crystal panel according to claim 4, wherein
the first angle has a value larger than θ min and smaller than θ max under a condition of
θ max=−0.0040θ²+0.1300θ−0.7500
θ min=0.00040³+0.0080θ²+0.060θ−1.7500
wherein θ represents an angle formed with the absorption axis of the second polarizing plate and a horizontal direction within a surface of the liquid crystal panel with respect to a display screen of the liquid crystal panel.

7. The liquid crystal panel according to claim 4, wherein
the absorption axis of the second polarizing plate is parallel to the horizontal direction within the surface of the liquid crystal panel with respect to the display screen of the liquid crystal panel, and
the first angle has a value greater than 0.75° and smaller than 1.75° in a counterclockwise direction.

8. The liquid crystal panel according to claim 4, wherein
the absorption axis of the second polarizing plate is parallel to the horizontal direction within the surface of the liquid crystal panel with respect to the display screen of the liquid crystal panel, and
the first angle has a value greater than 0.75° and smaller than 1.75° in a clockwise direction.

9. The liquid crystal panel according to claim 1, wherein the second angle is 1.5 times or more and 2.5 times or less of the first angle (θ₅).

10. A liquid crystal display device comprising:
the liquid crystal panel according to claim 1; and
a lighting device configured to light the liquid crystal panel.
